(19) United States
(12) Patent Application Publication
(10) Pub. No.: US 2024/0051852 A1
(43) Pub. Date: Feb. 15, 2024

(54) GREY WATER SYSTEM

(71) Applicant: Kohler Co., Kohler, WI (US)

(72) Inventors: William C. Kuru, Plymouth, WI (US); Jason M. Kwacz, Kohler, WI (US)

(21) Appl. No.: 18/232,633

(22) Filed: Aug. 10, 2023

Related U.S. Application Data
(60) Provisional application No. 63/398,039, filed on Aug. 15, 2022.

(51) Int. Cl. C02F 1/34

(52) U.S. Cl. CPC C02F 1/34; C02F 2103/002

(57) ABSTRACT

A shear clarification device includes an input, a shear flow tube, a first output and a second output. The input to the shear clarification device receives water from a water consuming appliance. The shear flow tube is configured to place forces on particles in a water flow from the input toward an outer portion of the shear flow tube. The first output is coupled to the outer portion of the shear flow tube. The second output is coupled to an inner portion of the shear flow tube.

This application claims priority benefit of U.S. Provisional Application No. 63/398,039 (Docket No. 10222-22023 A) filed Aug. 15, 2022, which is hereby incorporated by reference in its entirety.

### FIELD

The present application relates to a grey water system.

### BACKGROUND

Water consumption is a growing problem. According to recent reports, in approximately 25 years, fresh water may become very scarce. Some predictions state that the entire world's population may suffer a water shortage or otherwise be adversely affected by the year 2040. Within an ever growing population is the ongoing demand for commercial goods in which requires water for manufacturing. This industrial practice, particularly in time of drought and with the ongoing global pollution of lakes, rivers and oceans, only continues to aggravate the potentials for looming shortages.

According to the Environmental Protection Agency (EPA), the average American family uses approximately 870 liters of water per day. Efforts to reduce consumption to a fraction of this level may require drastic changes in lifestyle unless significant changes are made to the everyday practices of bathing, laundry, and cleaning. Therefore, the following disclosure relates to improvements to water conservation through recycling.

### BRIEF DESCRIPTION OF THE DRAWINGS

Exemplary embodiments are described herein with reference to the following drawings, according to an exemplary embodiment.

FIG. 1 illustrates an example flow including particles.

FIG. 2 illustrates an example clarification device for a grey water system.

FIG. 3 illustrates another example clarification device for a grey water system.

FIG. 4 illustrates another example clarification device for a grey water system.

FIG. 5 illustrates an example grey water system.

FIG. 6 illustrates another example grey water system.

FIG. 7 illustrates an example block diagram for the grey water system.

FIG. 8 illustrates an example electrocoagulation device.

FIG. 9 illustrates another example electrocoagulation device.

FIG. 10 illustrates an example top view and side view for the electrocoagulation device.

FIG. 11 illustrates an example electrocoagulation device with perpendicular electrodes.

FIG. 12 illustrates an example flow chart for the grey water system.

FIG. 13 illustrates another example flow chart for the grey water system.

FIG. 14 illustrates an example controller for any of the disclosed embodiments.

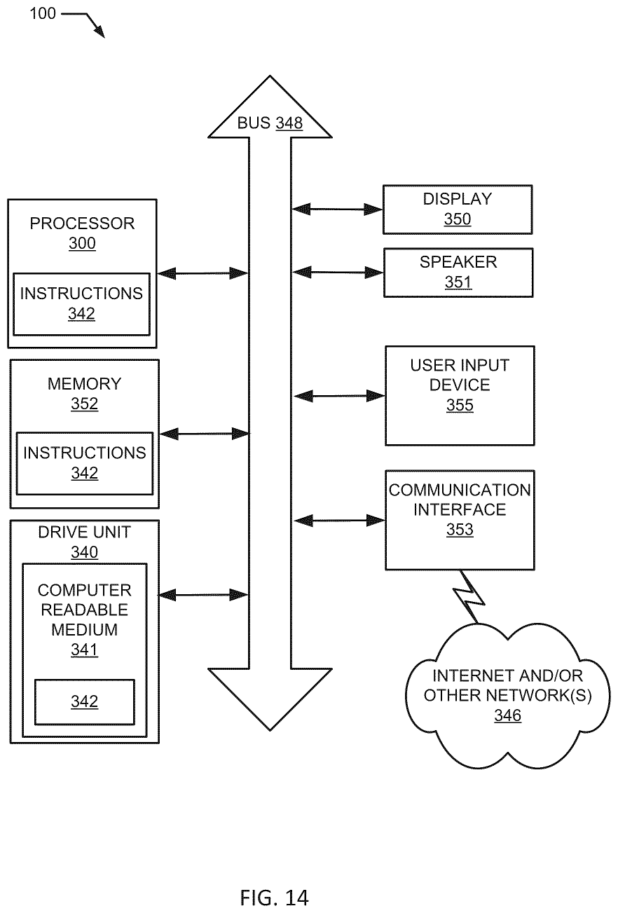

### DETAILED DESCRIPTION

Three different types of water associated with certain buildings and homes include potable water, greywater (grey water) and black water (blackwater). Potable water is provided by a well or the utility and often regulated in regard to safe delivery. Certain types of household waste water commonly referred to as greywater, may be generated through activities such as, washing dishes, clothes, brushing teeth, taking baths, showers, or any water utilized in which is not directly related to human waste (e.g., toilets or urinals). Related water consuming appliances include dishwashers, washing machines, showers, sinks, lavatories and other devices. Black water may be waste output from toilets, urinals, or other specified devices.

Some of the following embodiments introduce flow induced particle migration (e.g., shear migration and clarification) of water in a greywater treatment system. The flow induced particle migration may be the only treatment stage in the greywater treatment system. In other examples, the flow induced particle migration may be combined with other treatment stages (e.g., electrocoagulation) in the greywater treatment system. After exiting the greywater treatment system, the water is returned to one or more appliances such as a toilet or an irrigation system for reuse. It is possible for all or substantially all of the water consumed by one or more toilets, and/or by the irrigation system, to be fully supplied by the greywater system.

Greywater may contain many different types of contaminants including visible debris, suspended solids, dissolved solids, chemicals and biologicals. A variety of separation techniques are employed to remove the contaminants based upon the chemical, physical, or biological properties of the containment of interest. These separation techniques may be either slow and inexpensive (e.g., settling tanks), or aggressive and costly (e.g., centrifugal separation). This disclosure describes a separation technique that fits in the middle of this spectrum. These techniques are for particles that may be estimated as having a diameter between 1 to 1000 microns. This technique uses the principles of flow induced particle migration to separate the particles from the fluid.

Filters, settling tanks, and centrifugal separators are commonly used to separate particles from the bulk liquid. Sometimes coagulants are added to the fluid. These coagulants cause particle agglomeration creating larger particles for easier separation. Filter systems can require high pressure pumps depending upon the desired filter size. Both filters and settling tanks require occasional maintenance to remove the collected material and/or replace the filter. Filters can sometime fail without letting the user know there is a leak resulting in exposure to contaminated water.

The principle behind the flow induced particle migration device or clarifier is that under steady flow conditions particles migrate towards regions of balanced fluid forces. Regions of high particle concentration may then be diverted to waste leaving the clarified water stream to return to the holding tank.

Benefits of this system or device include (1) it separates particles based upon their size and shape and not density, (2) it may be installed downstream of any pump, (3) it is relatively small, (4) if does not require maintenance or replacement, and (5) it may be used upstream of finer filtration to improve the life of the filter. This proposed device may also be installed at the point-of-use if pumps are present. This is the best place to separate the contaminants because the particle concentrations are in the highest concentration at this point. Finally, this technique will work with neutrally buoyant particles. Settling and centrifuges will not.

The following embodiments may include plumbing devices that incorporate a migration and/or clarification device. The plumbing devices may include pipes, faucets, bathtubs, showers, water softeners, water heaters, toilets or other devices. The term “plumbing fixture” refers to an apparatus that is connected to a plumbing system of a house, building or another structure. The term “bathroom fixture” may more specifically refer to individual types of plumbing fixtures found in the bathroom. The term “kitchen fixture” may more specifically refer to individual types of plumbing fixtures found in the kitchen.

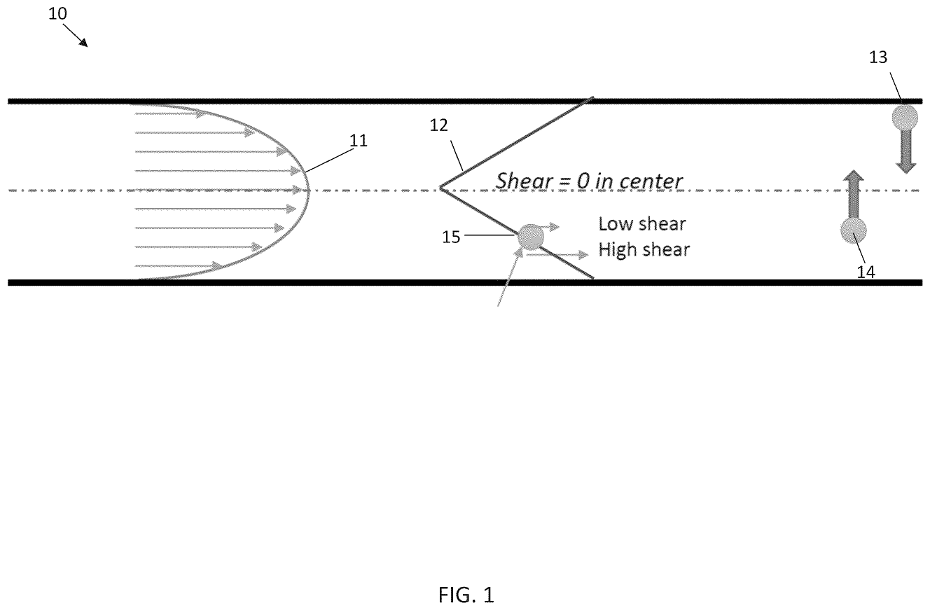

FIG. 1 illustrates an example flow through a plumbing fixture or pipe 10. A flow through the pipe 10 includes water and particles of a variety of shapes, sizes, and densities. Example particles at various states and/or positions are illustrated by particles 13, 14, and 15.

A line 12 illustrates the shear of the particles. Shear describes the stresses on fluid in motion developed due to the particles in the fluid moving relative to one another. Shear may be explained with respect to velocity. For the fluid in pipe 10, the velocity is zero or near zero next to the wall of the pipe 10. A line 11 illustrates the velocity profile of the flow of the pipe 10.

Velocity is higher on portions of the fluid toward the center of the pipe 10. Shear forces are caused by the adjacent layers of the fluid that move with different velocities with respect to each other. The particles in the center of the pipe 10 experience little to no shear. The particles near the outer circumference (e.g., particle 15) experience higher shear.

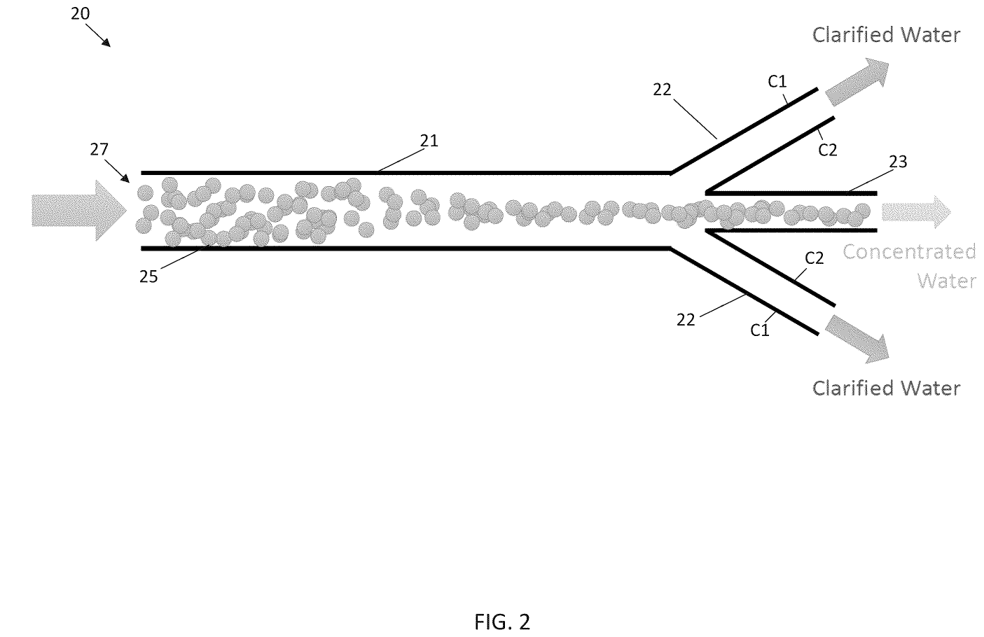

FIG. 2 illustrates an example clarification device 20 for a grey water system. The clarification device 20 includes a pipe having a main portion 21 that splits into central portion 23 and a radial portion 22. The main portion 21 and the central portion 23 are cylindrical or pipe-shaped (e.g., having a circular cross section). The main portion 21 and the central portion 23 may have a different shape. Example shapes for the cross-section include a triangle, a square, a rectangle, a quadrilateral, a diamond, a star, or another shape. The radial portion 22 may also have any of these shapes.

In these examples, the radial portion 22 may include an upper branch and lower branch (i.e., an upper pipe that branches from the main portion 21 in a first direction and a lower pipe that branches from the main portion 21 in a second direction). In another example, the radial portion may have a hollow conical section. That is, the radial portion 22 may be a single tube that encircles the central portion represented by line 12. The radial portion 22 and the central portion 23 may divide the water from the flow of the pipe 10 from the particles in the flow of the pipe 10. Additional, different, or fewer components may be included.

The opening 27 to the main portion 21 (main pipe), or alternately a section of the main portion 21, is an input to the shear clarification device 20 receives water from a water consuming appliance. The water consuming device may be any of the examples described herein such as a dishwasher, shower, sink or other device. The main portion 21 comprises a shear flow tube configured to place forces on particles in a water flow from the input toward an outer portion of the shear flow tube. The particles may generally migrate or move toward the inner portion of the tube, and the water (i.e., water with a low number of particles or no particles) may remain or migrate toward the outer portion of the tube. The shape of the main portion 21 may define the shear in the shear flow tube. In certain shapes, the particles may migrate away from a corner of the cross-sectional shape (e.g., square, rectangle, or other quadrilateral shape). In certain shapes, the particles may migrate away from a vertices of the cross-sectional shape (e.g., triangle or star).

As illustrated by FIG. 2, there are two outputs connected to the main portion 21. The radial portion 22 is a first output coupled to the outer portion of the shear flow tube. The radial portion 22 may include one or more tubes or pipes or a cone-shaped path defined by a cone having an outer diameter (C1) and an inner diameter (C2), as illustrated in FIG. 2 to define a single passage for the clarified output of the clarification device 20. The central portion 23 is a second output coupled to an inner portion of the shear flow tube. The central portion 23 may lead to a concentration output. The concentration output may be recirculated to an input of the clarification device 20. The concentration output may be connected to a waste tank or a connection to a sewer or septic system.

Various parameters of the clarification device 20 such as the diameter of the shear tube (main portion 21), length of the shear tube (main portion 21), position of the radial portion 22, the angle of the radial portion 22, the outer diameter (C1) and/or the inner diameter (C2) may be selected according to one or more characteristics of the flow. Example characteristics may include the flow rate, the particle concentration, the Reynolds number. In addition, parameters of the clarification device 20 may impact the selection of other parameters (i.e., there may be a relationship between diameter and length).

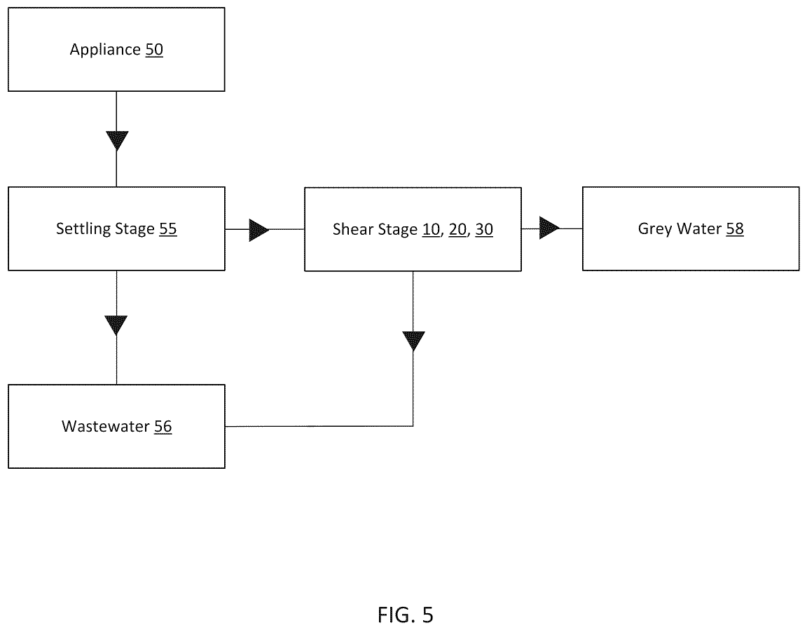

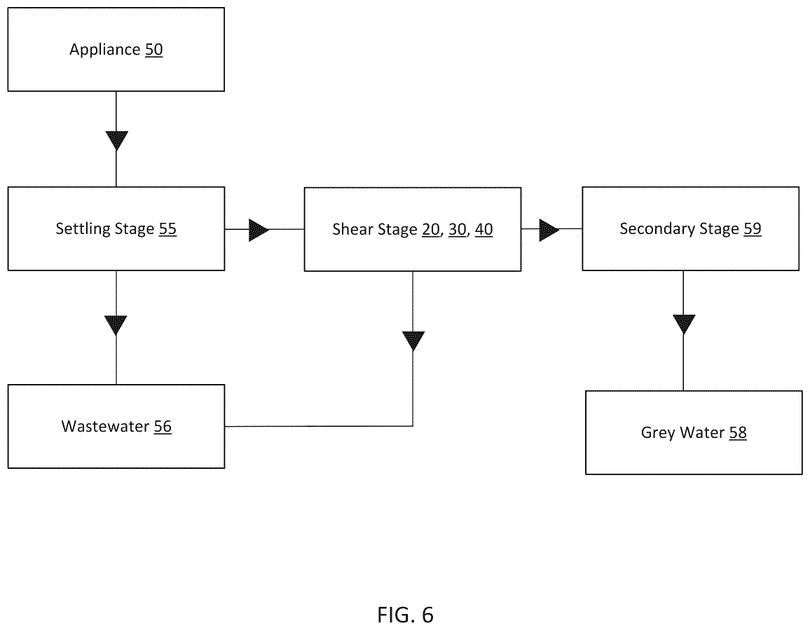

As described in more detail with respect to FIGS. 5 and 6, the clarification device 20 may be fluidly coupled to other stages or treatment devices. The outer portion 22 of the clarification device 20 may be connected to a grey water tank, which stores the water for subsequent or simultaneous use in another water consuming device.

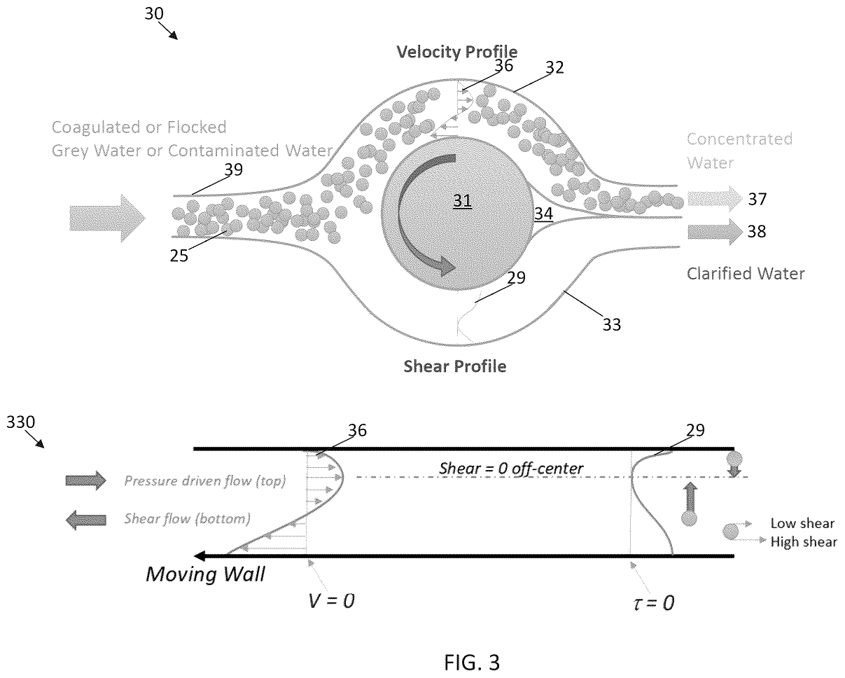

FIG. 3 illustrates another example clarification device 30 for a grey water system. The clarification device 30 includes a shear flow tube 39 that divides into a concentrated passage 32 and a clarified passage 33 surrounding a reverse cylinder 31. A first output 37 is connected to the concentrated passage 32, and a second output 38 is connected to the clarified passage 33. Additional, different, or fewer components may be included.

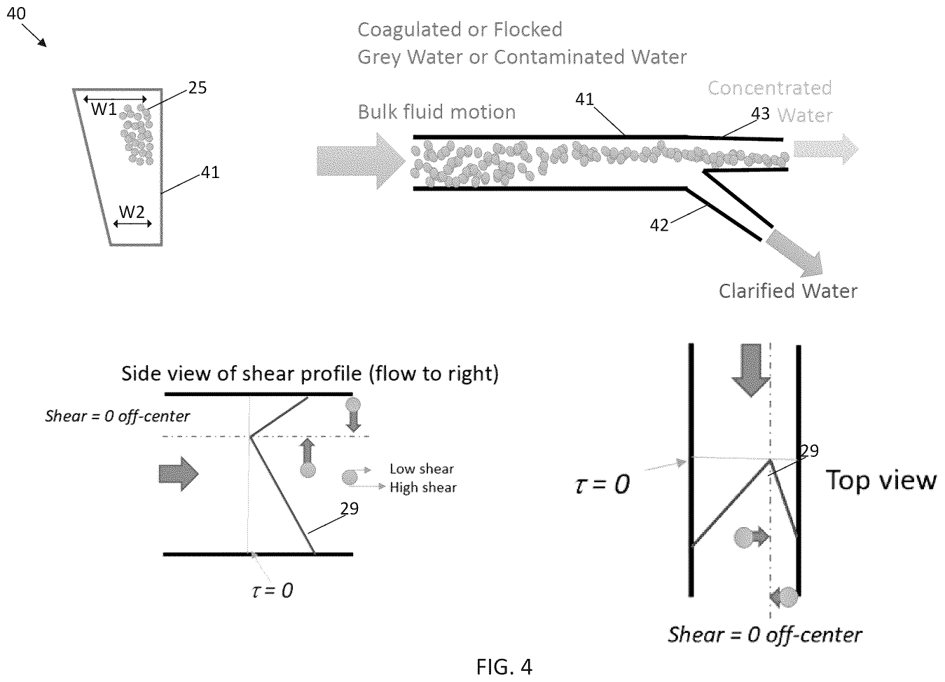

Water including particles 25 flows in a predetermined direction through the shear flow tube 39 (e.g., left to right in FIG. 4). The shear flow tube 39 is configured to place forces on particles in a water flow through the rotation of the reverse cylinder 31. The reverse cylinder 31 within the shear flow tube 39 rotates in a direction opposing the water flow. The result of a pressure driven flow and an opposing rotating inner cylinder 31 is an asymmetric velocity and shear profile. By varying the rotation rate and the pressure we can skew the velocity profile and shear stress profiles. Particles migrate towards regions of low shear. In this case low shear occurs in the parabolic region of the velocity profile. A fraction of the water (concentrated) flows with the parabolic profile. The other portion of the bulk water flow moves with the wall-driven shear profile. The wall-driven shear region has the greatest amount of shear and particles tend away from this region. As shown by velocity profile 36 and shear profile 29, particles are pushed toward the outer portion of the concentrated passage 32. Both the shear profile 29 and the velocity profile 36 are asymmetric. The clarified water, on the other hand, is pushed by the reverse cylinder 31 toward the clarified passage 33.

Diagram 33 illustrates the shear flow of clarification device 30. The reverse cylinder 31 (moving wall) causes reverse pressure on the particles near the reverse cylinder 31 as shown the velocity profile 36. The peak of the velocity in the flow direction is off center. Thus, as shown by shear profile 29, the zero shear level, which coincides with the peak velocity, is also off center.

The first output 37 is fluidly connected to the concentrated passage 32 on a first side of the reverse cylinder 31 and the second output 37 is fluidly connected to the clarified passage 33 on a second side of the reverse cylinder 31.

The clarification device 30 may also include a divider 34 between the concentrated passage 32 and the clarified passage 33. The divider 34 is adjacent to the reverse cylinder 31. The divider 34 may be spaced from the reverse cylinder 31 by a predetermined distance (e.g., 1 millimeter). The divider 34 may be formed from rubber.

The clarification device 30 may also include a motor configured to rotate the reverse cylinder 31 in the direction opposing the water flow. The motor may be operated at all times, or when the water is flowing through the shear flow tube 39. In some examples, a controller operates the motor in response to sensor data. For example, the sensor data may describe a flow in the clarification device 30 so that the motor is turned on when water is flowing through the clarification device 30.

The reverse cylinder 31 may have a predetermined diameter. The shear flow tube 39 has a predetermined diameter, or alternatively the sum of the diameters of the concentrated passage 32 and the clarified passage 33 may be a predetermined length. The ratio of the diameter of the shear flow tube 39 to the sum of the diameters of the concentrated passage 32 and the clarified passage 33 may be approximately 1, or in the range of 0.5 to 2.0.

Various parameters of the clarification device 30 such as the diameter of the tube (concentrated passage 32 and/or clarified passage 33), the length of the tube 39, the diameter of the tube 39 may be selected according to one or more characteristics of the flow. Example characteristics may include the flow rate, the particle concentration, the Reynolds number. In addition or int the alternative, various parameters of the clarification device 30 may be selected according to the speed of the reverse cylinder 31. In addition, parameters of the clarification device 20 may impact the selection of other parameters (i.e., there may be a relationship between diameter and length).

FIG. 4 illustrates another example clarification device 40 for a grey water system. FIG. 4 is an asymmetric flow tube. Example asymmetric flow tubes may include quadrilateral cross sections that are not rectangular or parallelogram. As shown, the cross sectional area of at least the shear tube 41 is a quadrilateral. The quadrilateral has four internal vertices or corners. One side (e.g., a concentrated side) of the shear tube 41 may have the largest cross section dimension (W1), and another side (e.g., a clarified water side) of the shear tube 41 may have a smaller cross section dimension (W2). The asymmetric channel shape causes an asymmetric shear distribution. The varying geometry of throughout the cross-section creates the difference in shear. Particles migrate toward regions of low or lower shear. This may be the side with the relatively “larger” dimensions. Other shear distributions are possible. The side view and top view in FIG. 4 illustrates the shear profile 29 with a zero point that is off center.

An input to the shear tube 41 receives water from a water consuming appliance. The shear tube 41 places forces on particles in a water flow from the input toward predetermined corner of the shear flow tube 41. A main portion 43 and a radial portion 42 branch from the shear flow tube 41. The main portion 43 is a first output coupled to the predetermined corner of the shear flow tube 41. The radial portion 42 is a second output coupled to a clarified portion of the shear flow tube. Since particles migrate towards regions of lowest shear asymmetric channel shapes have a benefit. Tight corners will have greater amounts of shear along the walls. Particles move away from these regions. In general particles will move towards the more ‘open’ regions of the channels. The most ‘open’ region of the channel or shear flow tube may be the region that corresponds to the one or more vertices with the greatest internal angle and/or the largest cross section dimension, as shown in FIG. 4.

FIGS. 5 and 6 illustrate an example grey water system using at least one of the clarification devices described herein. In FIG. 5, the clarification device is preceded by at least one stage. In FIG. 6, the clarification device is preceded by at least one stage and feeds into at least one subsequent stage. The grey water system may be on a bathroom level with multiple bathroom plumbing fixtures or devices connected to the grey water device and/or grey water tank. The grey water system may be on a whole home level or whole building (commercial such as hotel, etc.) level.

The grey water system of FIG. 5 includes an appliance 50, a settling stage 55, and the shear stage (clarification device). The settling stage 55 receives used water from the appliance 50 and divides in between wastewater 56 and an intermediate water flow. The settling stage 55 may include a settling tank where the heaviest or most dense particles are settled for easy removal. In addition, or in the alternative, the most buoyant or least dense particles may be skimmed from the top of the water.

The wastewater 56 may be provided to a sewer or a septic system. The shear stage again divides the intermediate water into grey water 58 (clarified flow such as radial portion 22, 42 or first output 37 in FIGS. 2-4) and additional wastewater 56 (concentrate flow such as central portion 23, 43 or second output 38 in FIGS. 2-4). The concentrate flow may be provided to a supplemental treatment device, a grey water tank, or return to the shear clarification device or another clarification device in a recirculation path or second clarification path. The concentrate flow may be provided to a waste path.

The grey water system of FIG. 6 includes an appliance 50, a settling stage 55, and the shear stage (clarification device). The settling stage 55 receives used water from the appliance 50 and divides in between wastewater 56 and an intermediate water flow. The wastewater 56 may be provided to a sewer or a septic system. The shear stage again divides the intermediate water into an input (clarified flow in FIGS. 2-4) to a secondary stage 59 and additional wastewater 56 (concentrate flow in FIGS. 2-4).

The secondary stage 59 may include another type of treatment for the water. The secondary stage 59 may include a disinfectant. The secondary stage 59 may include an ultraviolet (UV) light that irradiates the water. The secondary stage 59 may include an ozone generator that provides ozone (O₃) to the water as a disinfectant. Ozone may be formed by the ozone generator using a variety of techniques, including corona discharge, and cold plasma. For example, a corona charger may be configured to accumulate electric charge from a power source and apply the electric charge to air from an air source. In corona discharge, a corona discharge tube or an ozone plate is used. For example, a high voltage may be applied to an electrode in discharge tube or on the ozone plate. A corona discharge is an electrical discharge caused by the ionization of air surrounding the conductor carrying the high voltage. The air around the conductor undergoes an electrical breakdown to become conductive (e.g., temporarily) so that charge can leak off of the conductor and into the air. A corona occurs at locations where the strength of the electric field (potential gradient) around a conductor exceeds the dielectric strength of the air. The output of the secondary stage 59 may be grey water 58, which may be stored in a tank or otherwise provided to a water consuming appliance.

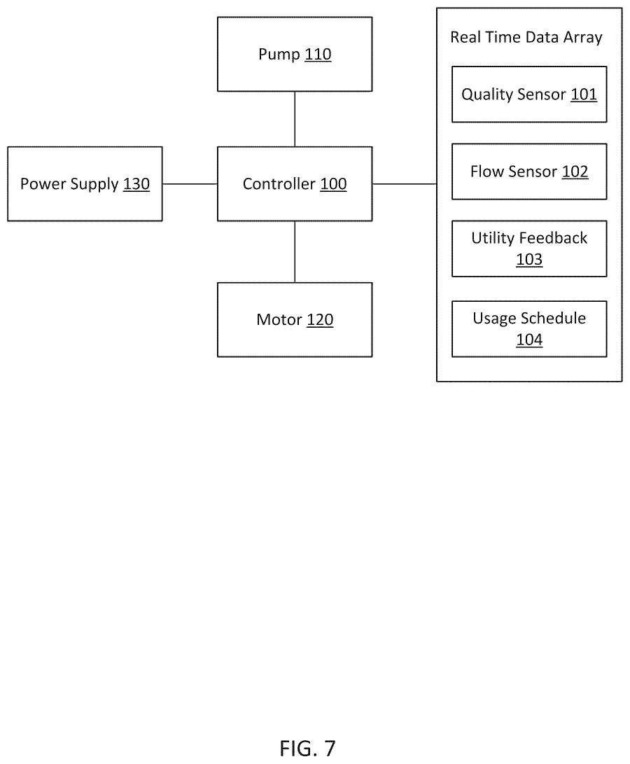

FIG. 7 illustrates an example block diagram for the grey water system. A controller 100 may receive data from the real time data array. The controller 100 may analyze the data to assess operation of the grey water system or assess the quality of the water therein. Based on the analysis, the controller 100 may generate and send commands to a pump 110, a motor 120, and a power supply 130. The real time data array may include any one or a combination of quality sensor 101, a flow sensor 102, a utility feedback 103, and a usage schedule 104. Additional, different or fewer components may be included.

The usage schedule 104 may include data that describes water usage as measured within the home or building. The usage schedule 104 may describe when the home or building uses water throughout the day, week, or year. The usage schedule 104 may be a historical log of the amount of water used at particular times. The usage schedule 104 may specify what water consuming devices are used and at what frequency. The utility feedback 103 may include data that describes water usage or costs and/or electricity usage or costs that have occurred or are anticipated.

The water quality sensor 101 may be configured to measure properties of the water such as turbidity or particulate matter, concentrations of certain chemicals, transparency, acidity (pH), dissolved solids (specific conductance), or dissolved oxygen. The water quality sensor 101 may also measure temperature in combination with any of these properties.

The flow sensor 102 may detect the amount of water entering the gray water system. The flow sensor 102 may detect the amount of water flowing through the clarification device or the electrocoagulation device. The flow sensor 102 may detect the presence or absence of a flow of water.

The pump 110 may be used to drive the water flow in any of the embodiments described herein. The controller 100 may generate and provide instructions to the pump 110. The pump 110 may be driven in response to the quality sensor 101, for example, when water quality falls below a predetermined threshold, the pump 110 is causes to pump more water through the grey water system. The pump 110 may be driven in response to the flow sensor 102, for example, the pump 110 may be activated when water is present. The pump 110 may be driven in response to the utility feedback 103, for example, during times of anticipated water usage or low electricity rates, the pump may be activates. The pump 110 may be driven in response to the usage schedule 104 of the user.

The motor 120 may be operated for the reverse cylinder in the example of FIG. 3. In any of these examples, the motor 120 may be operated by the power supply 130 based on instructions received from the controller 100. The motor 120 may be driven in response to quality sensor 101 indicating that the property of the water has fallen below a predetermined threshold. The motor 120 may be driven in response to the flow sensor 102 indicating that water is present at the clarification device. The motor 120 may be driven in response to the utility feedback 103 or the usage schedule 104 indicating anticipated or actual water usage.

The power supply 130 may also be controlled to operate an ozone generator such as a corona charger. The power supply 130 may also be controlled to operate a UV light. The power supply 130 may be activated by instructions from the controller 100 in response to the flow sensor 102 indicating water flow in the grey water system. The power supply 130 may be activated in response to the quality sensor 101 indicating the water quality has fallen below a threshold.

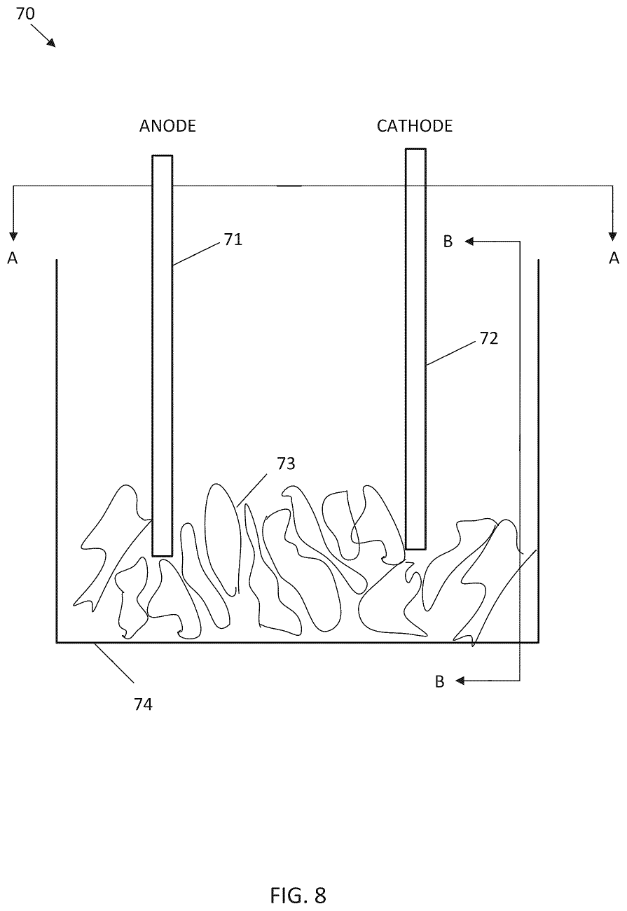

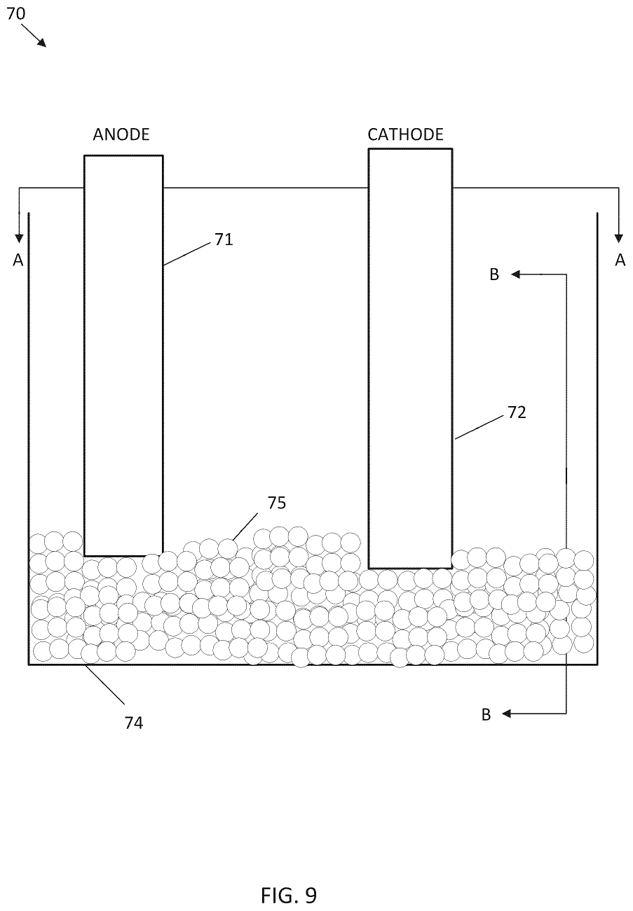

FIGS. 8 and 9 illustrate example electrocoagulation devices 70. An electrocoagulation device 70 may be used in the greywater systems of FIGS. 6 and 7. The electrocoagulation device 70 may be used in the settling stage 55 or the secondary stage 59. In some, examples, an electrocoagulation device 70 may replace the shear stage.

Electrocoagulation based greywater systems have the ability to treat greywater without the need for additional chemicals, replaceable filters or membranes, have the ability to operate at all times or for a significant amount of continuous time. The electrocoagulation device 70 may have a batch processes on the order of 10 to 30 minutes versus biological systems, which require 5 or more hours.

The electrocoagulation device 70 includes an anode 71 and a cathode 72 mounted in a housing 74. The electrocoagulation device 70 may also include a sacrificial metal. The sacrificial metal may include strips of metal 73 (e.g., steel, aluminum, etc.), as illustrated in FIG. 8. The sacrificial metal may include iron pellets 75, as illustrated in FIG. 9. Electrodes can use direct current, alternating current, and/or pulsed electric fields. In some examples, the anode 71 and/or cathode 72 may have a smaller diameter or cross section on the upper portion (e.g., not in contact with the sacrificial metal) and a larger diameter or cross section on the lower portion (e.g., in contact with the sacrificial metal).

The anode 71 and/or cathode 72 may be formed from iron, aluminum, steel, copper, magnesium, zinc, or any combination thereof. These electrodes may be formed with or without coatings such as boron doped diamond, titanium oxides, hydrophobic nanocomposites, etc. aimed at reducing or eliminating electrode material loss. To further reduce the depletion of the primary electrodes, sacrificial material such as shredded aluminum cans or iron pellets can be placed in the matrix between the electrodes. Other iron-based scrap metal can be used as sacrificial material to extend the life of the electrodes.

The electrocoagulation device 70 may be configured to apply an electrical charge to water (e.g., in the housing 74), which applies a surface charge to particles in the water, allowing the particles to form an agglomeration. The agglomeration of particles may be easily removed from the water or the housing 74. The agglomerations may separate emulsions, suspensions, heavy metals, and other particles from the water.

The anode 71 and cathode 72 may be connected to a power supply (e.g., DC power supply or battery). The anode 71 may electrochemically corrode or oxidation in response to a direct current provided by the power supply. The anode 71 may be subjected to passivation, which may include a coating on the cathode 72 that at least in part prevents corrosion of the cathode 72.

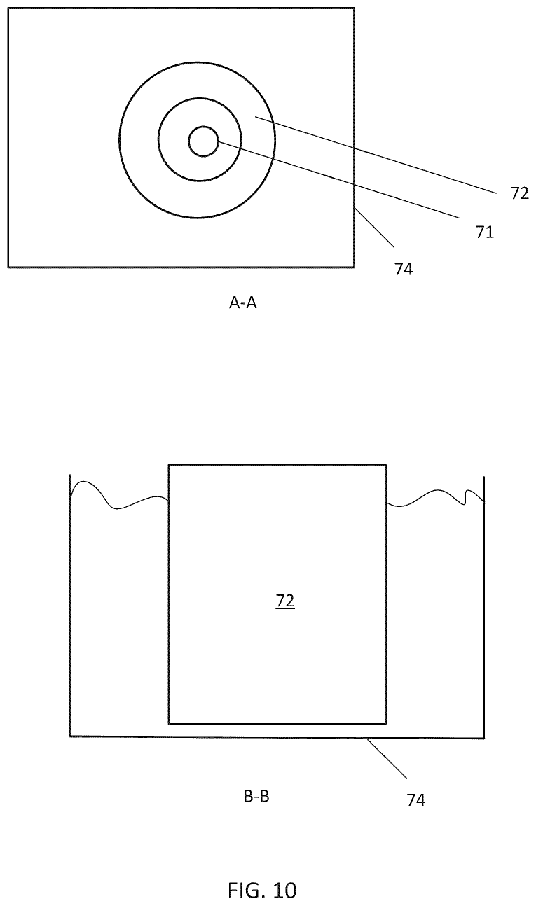

FIG. 10 illustrates an example top view and side view for the electrocoagulation device. The anode 71 and the cathode 72 may be concentrically arranged. That is, the cathode 72 may be shaped as ring with a height (e.g., hollow cylindrical shape). The anode 71 may cylindrical and positioned in the cathode 72. The electrodes may be rotated. The rotating electrodes may be rotated by a motor, a solenoid, or another drive mechanism may be coupled to the anode 71 and/or the cathode 72. The anode 71 and/or the cathode 72 may be rotated at a predetermined speed and/or at predetermined intervals.

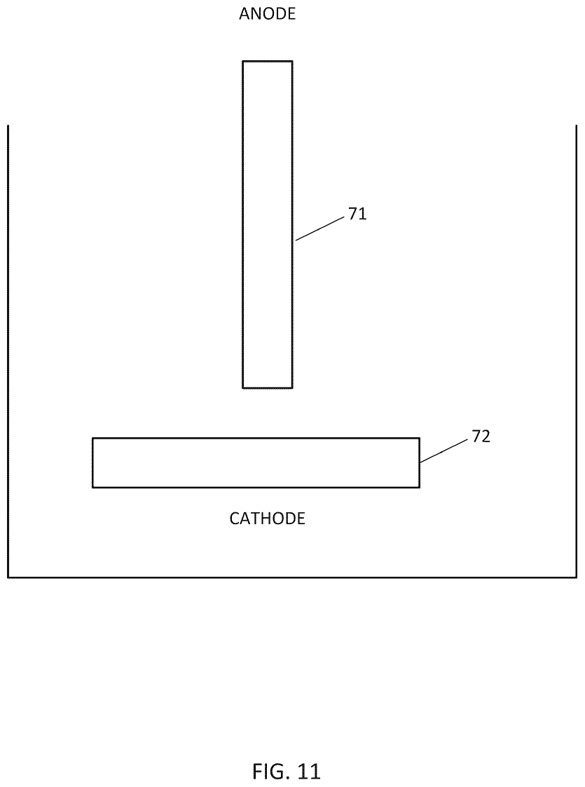

FIG. 11 illustrates an example electrocoagulation device with perpendicular electrodes including a vertical anode 71 and a horizontal cathode 72. The arrangement of perpendicular electrodes may improve electrical life (i.e., reduce the loss of material of the electrodes from corrosion and/or passivation). Other techniques to reduce the loss of material on the electrodes may include reversing polarity, rotating electrodes, an array of electrodes, or combinations thereof. For reversing the polarity, the polarity of the anode 71 and cathode 72 may be changed over time by the controller 100 according to a duty cycle. The duty cycle may be 5-20 minute cycles. Changing the polarity may prevent film buildup on the electrodes.

The electrocoagulation device 70 may include one or more additional filtering, treatment or disinfectant systems. Water upstream of the electrocoagulation device 70 or downstream of the electrocoagulation device 70 may be treated with electroflotation, dissolved air flotation, aeration, electro-oxidation, ultrasound, ozonation, hydrogen peroxide generation, chemical addition, carbon nanotube filtration, acoustic nanotubes, reverse osmosis, nanofiltration, ultrafiltration, microfiltration, graphene filtration, carbon/granulated activated carbon filtration, automatic variable filtration, and/or other filters and membranes. Skimmers may be used in the electrocoagulation device 70 to remove floc at the water surface and/or sludge from the bottom of the reactor (e.g., container or housing 74). Additional water treatment stages may include shock electrodialysis, rotating bed contactor, membrane bio reactor, sequential batch reactor, membrane aerated biofilm reactor, and moving bed bio reactor as possible devices implemented in combination with electrocoagulation device 70. These devices may treat water before or after treatment by the electrocoagulation device 70.

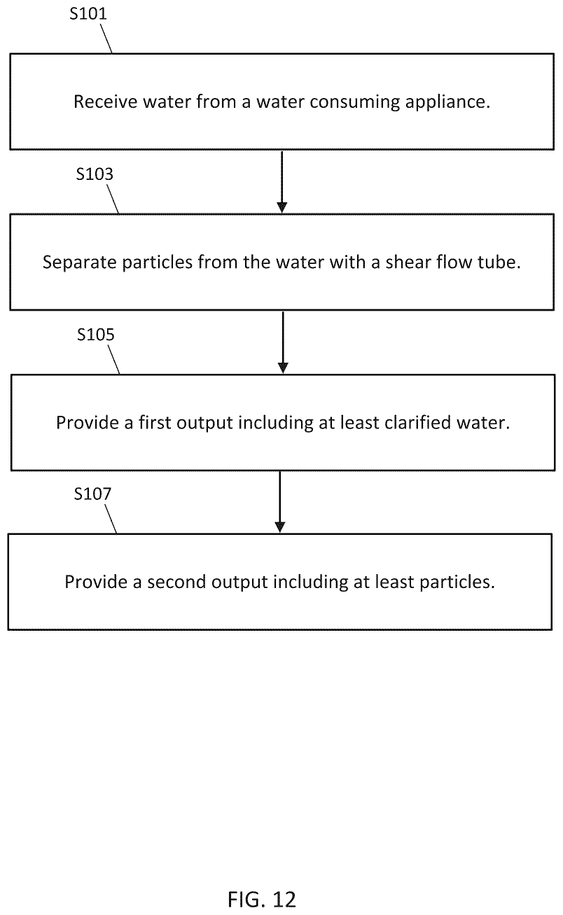

FIG. 12 illustrates an example flow chart for operation of a clarification device. Additional, different, or fewer components may be included.

At act S101, the shear clarification device receives water from a water consuming appliance. The water consuming appliances include devices that are connected to a water supply and also have a water drain such that particles are generally added to the water while being consumed by the appliance. Example water consuming appliances included dishwashers, washing machines, showers, sinks, lavatories and other devices.

At act S103, the shear clarification device separates particles from the water with a shear flow tube configured to place forces on particles in the water from the input toward an outer portion of the shear flow tube and away from an inner portion of the shear flow tube.

At act S105, the shear clarification device outputs a first portion of the water at the outer portion of the shear flow tube. At act S107, the shear clarification device outputs a second portion of the water at an inner portion of the shear flow tube.

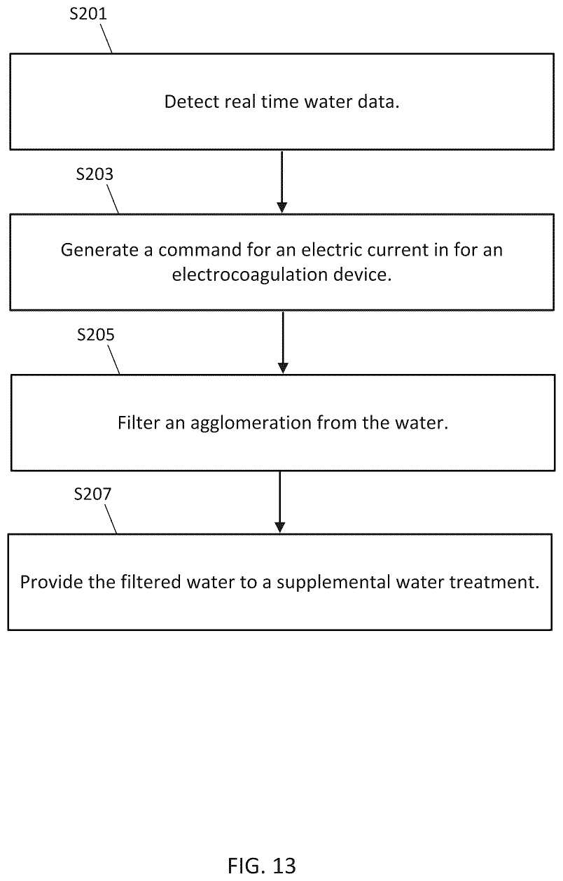

FIG. 13 illustrates an example flow chart for water treatment. Additional, different, or fewer components may be included.

At act S201, the controller 100 detects real time water data. The real time water data may be generated by a flow sensor or another type of sensor. The flow sensor may be a pressure sensor, ultrasonic sensor, or light sensor. The light sensor may measure the quantity of water that passes a light beam. The pressure sensor may detect the pressure of water inside a hose, a pipe or other plumbing device. The flow sensor may include two or more pressure sensors located at different places along a pipe. For example, the flow sensor may include a downstream pressure sensor and an upstream pressure sensor. The controller 100 may calculate the flow between the downstream pressure sensor and the upstream pressure sensor based on pressure measurements made by the respective sensors. The change in pressure may be proportional to the flow rate. The calculated flow may also be proportional to the size of the pipe (e.g., the square of the radius). The calculated flow rate may also depend on viscosity. The ultrasonic sensor generates an ultrasonic wave that travels through the flow of water and is received at a receiver. Based on the received ultrasonic wave the volume and/or speed of the flow of water is detected. The sensor may be paired with two polished surface that reflects the ultrasonic wave or the light beam on the opposite side of the flow of water and returns the ultrasonic wave or the light beam to the sensor. As an alternative to the flow sensor, the flow of water may be determined according to the operation of a valve. For example, a solenoid may open and close the flow of water. The controller 100 may control the solenoid to actuate in order to open or close the valve, for example, using an open command (e.g., energize the solenoid) and a close command (e.g., de-energize the solenoid). The open command, or turning on a valve or faucet, may be generated in response to a user command. The user command may be a mechanical button (e.g., move the faucet handle or knob) or a motion sensor (e.g., wave an arm or hand in front of the motion sensor). The controller 100 may calculate a flow rate using a time difference between the open command and the closed command. The controller 100 may include a lookup table that relates the amount of time that the valve or faucet is on to flow amounts. In some examples, the time between the open and close commands is a predetermined time period, and in turn, the flow rate for one operation of the valve or faucet is a set amount.

At act S203, the controller 100 generates a command for an electric current for an electrocoagulation device in response to the real time water data to form an agglomeration in the water. The corresponding electrical charge applies a surface charge to particles in the water, allowing the particles to form an agglomeration. The agglomeration of particles may be easily removed from the water or corresponding housing.

At act S205, the controller 100 filters the agglomeration from the water. At act S207, the filtered water is provided to a supplemental water treatment.

FIG. 13 illustrates an example control system or controller 100 for any of the embodiments described herein. The controller 100 may include a processor 300, a memory 352, and a communication interface 353 for interfacing with devices or to the internet and/or other networks 346. In addition to the communication interface 353, a sensor interface may be configured to receive data from the sensors described herein or data from any source. The controller 100 may include an integrated display 350, speaker 351, or other output devices. The components of the control system may communicate using bus 348. The control system may be connected to a workstation or another external device (e.g., control panel) and/or a database for receiving user inputs, system characteristics, and any of the values described herein.

Optionally, the control system may include an input device 355 and/or a sensing circuit 356 in communication with any of the sensors. The sensing circuit receives sensor measurements from sensors as described above. The input device may include any of the user inputs such as buttons, touchscreen, a keyboard, a microphone for voice inputs, a camera for gesture inputs, and/or another mechanism.

Optionally, the control system may include a drive unit 340 for receiving and reading non-transitory computer media 341 having instructions 342. Additional, different, or fewer components may be included. The processor 300 is configured to perform instructions 342 stored in memory 352 for executing the algorithms described herein. A display 350 may be an indicator or other screen output device. The display 350 may be combined with the user input device 355.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, the memory 352 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A shear clarification device comprising:
an input to the shear clarification device receives water from a water consuming appliance;
a shear flow tube configured to place forces on particles in a water flow from the input toward an outer portion of the shear flow tube;
a first output coupled to the outer portion of the shear flow tube; and
a second output coupled to an inner portion of the shear flow tube.

2. The shear clarification device of claim 1, wherein the second output is coupled to a supplemental treatment device.

3. The shear clarification device of claim 1, wherein the second output is coupled to a grey water tank.

4. The shear clarification device of claim 1, wherein the second output is coupled to a recirculation path.

5. The shear clarification device of claim 1, wherein the first output is coupled to a waste path.

6. The shear clarification device of claim 1, wherein the first output includes at least one tube having a cylindrical cross section.

7. The shear clarification device of claim 1, wherein the first output includes a cone shaped path.

8. The shear clarification device of claim 1, further comprising:
a settling tank configured to remove heavy particles from the water from the water consuming appliance.

9. A shear clarification device, further comprising:
an input to the shear clarification device receives water from a water consuming appliance;
a shear flow tube configured to place forces on particles in a water flow; and
a reverse cylinder within the shear flow tube and configured to rotate in a direction opposing the water flow, the reverse cylinder defining a first output a second output.

10. The shear clarification device of claim 9, further comprising:
a motor configured to rotate the reverse cylinder in the direction opposing the water flow.

11. The shear clarification device of claim 9, wherein the first output is fluidly connected a first path on a first side of the reverse cylinder and the second output is fluidly connected to a second path on a second side of the reverse cylinder.

12. The shear clarification device of claim 11, further comprising:
a divider between the first path and the second path, the divider adjacent the reverse cylinder.

13. A shear clarification device comprising:
an input to the shear clarification device receives water from a water consuming appliance;
a shear flow tube configured to place forces on particles in a water flow from the input toward predetermined corner of the shear flow tube;
a first output coupled to the predetermined corner of the shear flow tube; and
a second output coupled to a clarified portion of the shear flow tube.

14. The shear clarification device of claim 13, wherein the shear flow tube has a cross section that is a quadrilateral, rectangular, triangular, or star-shaped.

15. The shear clarification device of claim 13, wherein the second output is coupled to a supplemental treatment device.

16. The shear clarification device of claim 13, wherein the second output is coupled to a grey water tank.

17. The shear clarification device of claim 13, wherein the second output is coupled to a recirculation path.

18. The shear clarification device of claim 13, wherein the first output is coupled to a waste path.

19. The shear clarification device of claim 13, further comprising:
a settling tank configured to remove heavy particles from the water from the water consuming appliance.

20. The shear clarification device of claim 13, wherein the predetermined corner is associated with a largest width of the shear flow tube.

21-40. (canceled)
